(19) United States
(12) Patent Application Publication
(10) Pub. No.: US 2012/0119634 A1
(43) Pub. Date: May 17, 2012

(54) Stapler platform

(76) Inventor: Peter David Dalton, Los Angeles, CA (US)

(21) Appl. No.: 13/068,846

(22) Filed: Jan. 9, 2009

Related U.S. Application Data
(60) Provisional application No. 61/201,664, filed on Dec. 12, 2008.
(60) Provisional application No. 61/201,704, filed on Dec. 12, 2008.

(51) Int. Cl. B25C 7/00

(52) U.S. Cl. 312/237

(57) ABSTRACT

The present invention is a multi-function stapler platform. The stapler platform has a housing with a stapler cradle formed therein. The stapler platform also has a note pad compartment formed within the housing that is configured to accept and hold a note pad. In addition, there is a drawer compartment formed within said housing that is configured to accept and hold a drawer. The stapler platform can also include an adhesive flag dispenser.

### CROSS-REFERENCE TO RELATED APPLICATIONS

The applicant hereby claims benefit of U.S. Provisional Patent Application No. 61/201,664 (filed Dec. 12, 2008). The specification of said provisional patent application is incorporated herein by this reference as though set forth in full.

The applicant hereby claims benefit of U.S. Provisional Patent Application No. 61/201,704 (filed Dec. 12, 2008). The specification of said provisional patent application is incorporated herein by this reference as though set forth in full.

### STATEMENT REGARDING FEDERALLY SPONSORED RESEARCH OR DEVELOPMENT

Not Applicable

### FIELD OF INVENTION

The present invention relates to office desk accessories.

### BACKGROUND OF THE INVENTION

The present invention is a multi-functional stapler platform. A stapler is a common device used to bind material together by means of staples. A staple is a thin piece of wire in the shape of a square bracket that is driven by a device through sheets of paper or similar material and flattened to serve as a fastening. Staplers are very common devices on office desks. However, a stapler can take up significant space on a desk. The present invention allows better utilization of space on an office desk by providing a platform for a stapler that also performs other functions, such as providing a drawer to conveniently store paper clips and a compartment to store note pads. The present invention is described more fully below.

### SUMMARY OF THE INVENTION

The present invention is a multi-function stapler platform. The stapler platform has a housing with a stapler cradle formed therein. The stapler platform also has a note pad compartment formed within the housing that is configured to accept and hold a note pad. In addition, there is a drawer compartment formed within said housing that is configured to accept and hold a drawer. The stapler platform can also include an adhesive flag dispenser.

In the preferred invention, the drawer compartment and the note pad compartment share structures. For example, a wall of the note pad compartment might also serve as a support or a guide for the drawer when the drawer is inserted into the drawer compartment. The unique design allows the stapler platform to provide a number of useful features while remaining compact and taking little space on the user's desk.

### BRIEF DESCRIPTION OF THE DRAWINGS

The above and other objects and advantages of the present invention will be apparent upon consideration of the following detailed description, taken in conjunction with the accompanying drawings, in which reference characters refer to like parts throughout, and in which:

FIG. 1 is a frontal perspective view of the stapler platform with the stapler outside the stapler cradle;

FIG. 2 is a frontal perspective view of the stapler platform with the stapler in the stapler cradle;

FIG. 3 is a rear perspective view of the stapler platform;

FIG. 4 is a top view of the stapler platform;

FIG. 5 is a front view of the stapler platform;

FIG. 6 is a view of the left side of the stapler platform;

FIG. 7 is a rear view of the stapler platform;

FIG. 8 is a view of the right side of the stapler platform;

FIG. 9 is a bottom view of the stapler platform;

FIG. 10 is a frontal perspective view of the stapler platform wherein the drawer has been removed;

FIG. 11 is a perspective view of the drawer; and

FIG. 12 is shows the plan of the stapler platform floor viewed from the top after the housing has been removed.

### DETAILED DESCRIPTION OF THE INVENTION

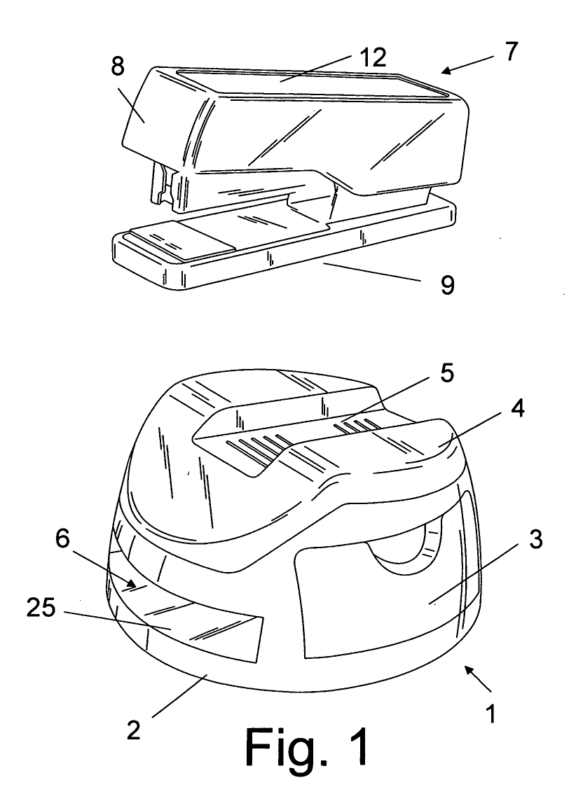

FIG. 1 shows a stapler 7. The stapler has a base 9 and a stapler mechanism 8 that are pivotally connected thereto. Sheets of paper can be placed be between the base 9 and the stapler mechanism 8 and, thereafter, the stapler mechanism 8 can be pressed down against the paper and base to cause the sheets of paper to be fastened together by a staple. In the preferred embodiment, the top of the stapler 7 comprises a substantial branding area 12. As can be seen in FIG. 1, the top of the stapler 7 is substantially flat and includes the large branding area 12. In the preferred embodiment, this branding area is a surface sunken into the top of the stapler. Typically, the branding area is substantially rectangular in shape.

Advertising, trademarks and other product or company information can be imprinted or otherwise applied on the branding area 12. It is preferred that the branding area 12 comprises most of the surface of the top of the stapler 7. In fact, it is preferred that the front branding area 12 comprise at least 90% of the surface of the top of the stapler. In the preferred embodiment, the branding area 12 comprises a sunken, substantially flat surface disposed within the surface of the top of the stapler. It is preferred that the sunken surface is substantially rectangular with rounded corners. In the preferred embodiment, the sunken surface is configured to accept adhesive labels that bear the desired branding. By using labels, the user can benefit from more elaborate and decorative printing processes, such as a four-color process.

The multi-functional stapler platform 1 includes a platform top 4. Formed within the platform top 4 is a stapler cradle 5 configured to accept the base 9 of the stapler 7. In the preferred embodiment, the stapler cradle 5 has a bottom surface and two side walls. The bottom surface supports the stapler when the stapler is placed in the stapler cradle 5 and the side walls keep the stapler from slipping out on the sides. The bottom surface can include ridges that prevent the stapler from sliding forward or backward.

The multi-functional stapler platform 1 also has a chamber body 2. In the preferred embodiment, the chamber body 2 is a hollow piece of plastic that forms the body of the multi-functional stapler platform 1. In the preferred embodiment, the platform top 4 is also a single piece of plastic that snaps into the chamber body 2. However, the chamber body 2 and the platform top 4 might also be formed together as a single piece of plastic. Other constructions are also possible within the ambit of the present invention.

In the preferred embodiment, the chamber body 2 is open at the bottom and has three additional openings formed therein. These three additional openings include a note pad compartment opening, a drawer opening and an opening for a adhesive flag dispenser. Two of those additional openings can be seen in FIG. 1. As shown in FIG. 1, the chamber body 2 includes a note pad compartment opening 6. When the multi-functional stapler platform is fully assembled, a note pad can be placed into the note pad compartment through the note pad compartment opening 6. In the preferred embodiment, the multi-functional stapler platform 1 is configured to accept a pad that is about 7½ centimeters wide, 7½ centimeters long, and 1 centimeter thick. In the preferred embodiment, when that sized note pad is fully inserted, its corners will stick out of the note pad compartment opening 6 a bit so that the user easily can grab the note pad and pull it out. In the preferred embodiment, the note pad can be inserted into the note pad compartment about 7.8 centimeters (measuring from the bottom, center point of the note pad compartment opening 6). In the preferred embodiment, the note pad compartment opening 6 is about 8 centimeters wide (measured with a straight-edged ruler) and about 1.5 centimeters high (also measured with a straight-edged ruler).

The other additional opening that can be seen in FIG. 1 is an opening that accepts a drawer. The drawer is for keeping paper clips or other items. In FIG. 1, the drawer has been placed in the multi-functional stapler platform 1 and the face 3 of the drawer can be seen. In the preferred embodiment, the drawer can be removed and reinserted by the user into the drawer opening.

Also shown in FIG. 1 is part of the chamber floor 25. The chamber floor 25 is described more fully below.

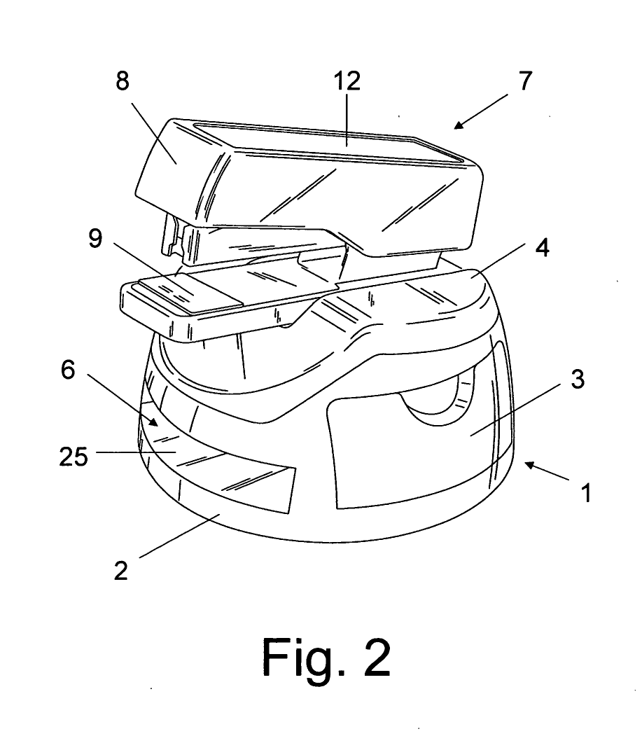

FIG. 2 shows the multi-functional stapler platform 1 after the stapler 7 has been placed within the cradle.

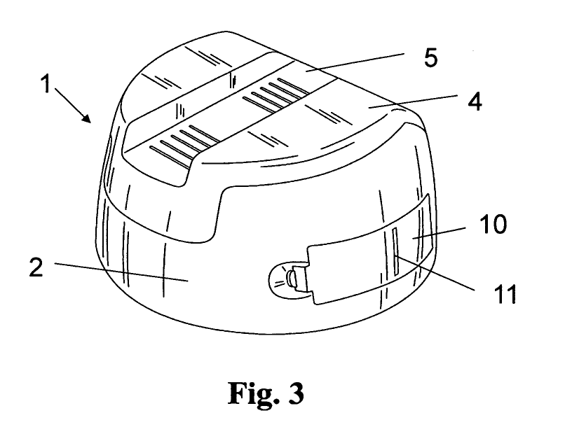

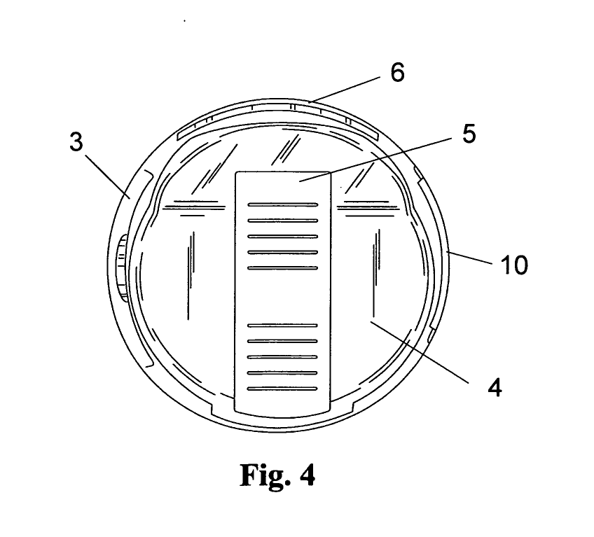

FIG. 3 provides a rear perspective view of the multi-functional stapler platform 1. As shown in FIG. 3, the chamber body 2 also has an opening for an adhesive flag dispenser. A flag dispenser cover 10 snaps into the flag dispenser opening. Behind the flag dispenser cover 10 is a compartment to hold a pad of adhesive flags. The compartment is described on more detail below. The flag dispenser cover 10 as a vertical slot 11 from which adhesive flags can be pulled out. The construction of adhesive flag dispensers are well known by those skilled in the art. For example, U.S. Pat. No. 7,143,922 (the “'922 patent”), describes an adhesive flag dispenser that can be utilized in the present invention. In the '922 patent, the adhesive flag dispenser is shown in FIGS. 3 and 4 and described in detail from column 3, line 52 to column 4, line 17. The entirety of the '922 patent is incorporated herein by this reference as though set forth in full. In the preferred embodiment of the present invention, the contour of the adhesive dispenser cover is shaped to match the contour of the surface of the multi-stapler platform 1.

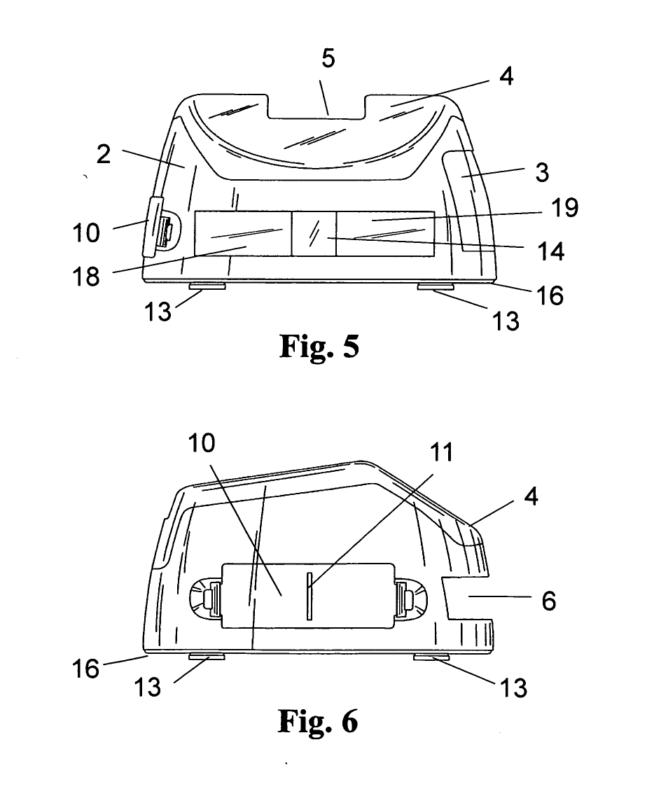

FIG. 4 provides a top view of the multi-functional stapler platform 1. FIG. 5 shows a front view of the multi-functional stapler platform 1. This view shows the inside of the note pad compartment. In the back of the note pad compartment is a rear wall, including a left portion 18 of the rear wall and a right portion 19 of the rear wall. Also shown is a note pad stop 14. The note pad stop 14 is in front of the rear wall and performs two functions. First, it stops the note pad so that the corners of the note pad jut out of note pad compartment opening 6 when the note pad has been placed all the way into the note pad compartment. Second, it supports the drawer when the drawer is inserted into the drawer opening. These features are described more fully in the discussion of FIG. 11 below. The note pad stop is preferably set back about 7.8 centimeters from the bottom, center of the note pad compartment opening 6.

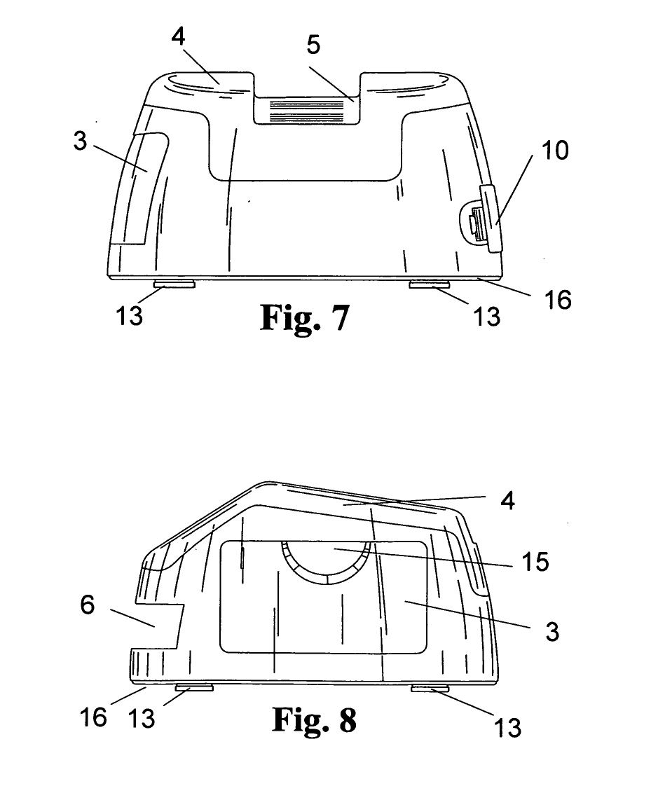

Support pads 13 can also be seen. In the preferred embodiment, there are four of these pads. These pads support a disk 16 on which the rest of the multi-stapler platform 1 sits. In the preferred embodiment, the rest of the multi-stapler platform 1 is rotatable with respect to the disk 16. FIGS. 6 and 7 provide left side and rear views of the multi-functional stapler platform 1, respectively.

FIG. 8 provides a right side view of the multi-functional stapler platform 1. From FIG. 8, it can be seen that a cut-out 15 is formed on the top of the drawer face 3. A user can put a finger through the cut-out 15 and thereby better grasp the drawer face 3 to open the drawer.

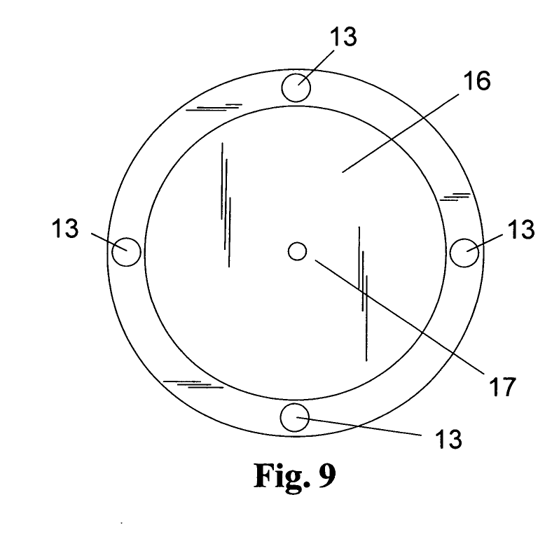

FIG. 9 provides a bottom view of the multi-functional stapler platform 1. The disk 16 is shown. Four support pads 13 can also be seen. There is a rivet 17 in the center of the disk 16 that connects the disk 16 to the floor 25 of the multi-functional stapler platform 1. When the entire device rests on a desk or other surface, the multi-functional stapler platform 1 can be rotated around the rivet 17 as the disk 16 remains stationary. Preferably, the side of the disk 16 not shown is substantially flat.

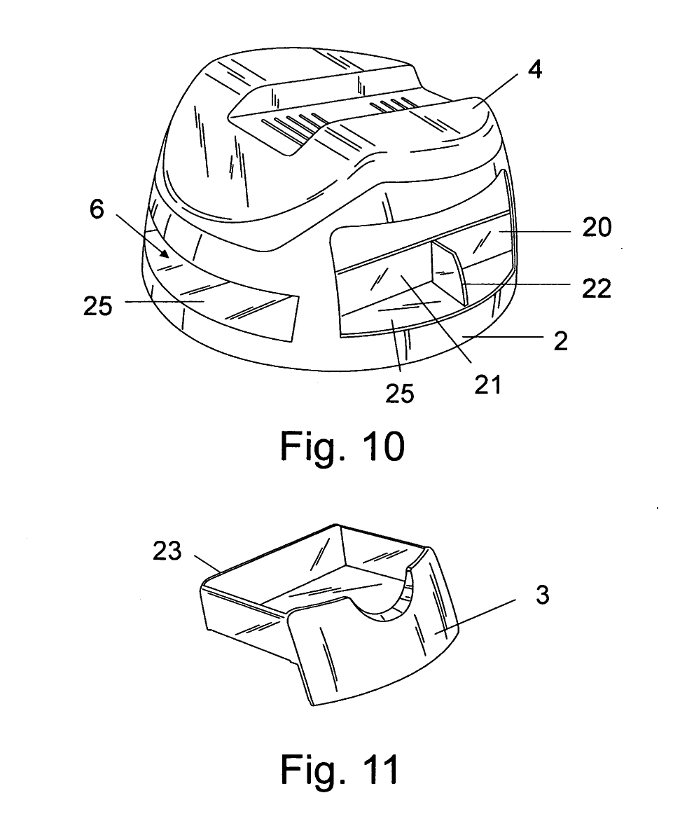

FIG. 10 provides a front perspective view of the multi-functional stapler platform 1 with the drawer removed. Through the drawer opening, FIG. 10 shows a drawer support structure that includes a right wall. The front portion of the right wall is shown as item 21 and the rear portion of the right wall is shown as item 20. Extending outward from the right wall is a drawer insertion guide 22. The drawer insertion guide 22 can be configured to act as a stop to prevent the drawer from being pushed too far into the multi-functional stapler platform 1. Alternatively, other means can be used to stop the drawer from being inserted too far, such as a lip at the bottom edge of the drawer opening. The top of the drawer support structure (including the drawer insertion guide 22) holds the drawer up when the drawer is inserted into the multi-functional stapler platform 1. Additionally, the drawer insertion guide 22 acts as a insertion guide to make it easier for the user to insert the drawer into the multi-functional stapler platform 1. As is described more fully below, the right wall also forms part of the note pad compartment. Typically, the front drawer support wall 21, rear drawer support wall 20 and drawer insertion guide 22 will all have the same height. The drawer support projection should be shaped to fit with the lower, interior side of the drawer face 3 when the drawer has been pushed in all the way. In the preferred embodiment, the drawer opening is about 7 centimeters wide (measured with a straight-edged ruler) and about 3.5 centimeters high (also measured with a straight-edged ruler).

FIG. 11 shows the drawer. The drawer includes the drawer face 3 and a drawer box 23. Preferably, the drawer box 23 has three walls and a bottom and is connected to the drawer face to form an open container that can hold, for example, paper clips. The drawer face 3 extends below the drawer box 23 so that, when the drawer is inserted into the multi-functional stapler platform 1, the drawer box 23 rests on the drawer support structure. At the same time, the drawer is blocked from going too far into the multi-functional stapler platform 1 because the drawer face 3 hits against the drawer insertion guide 22.

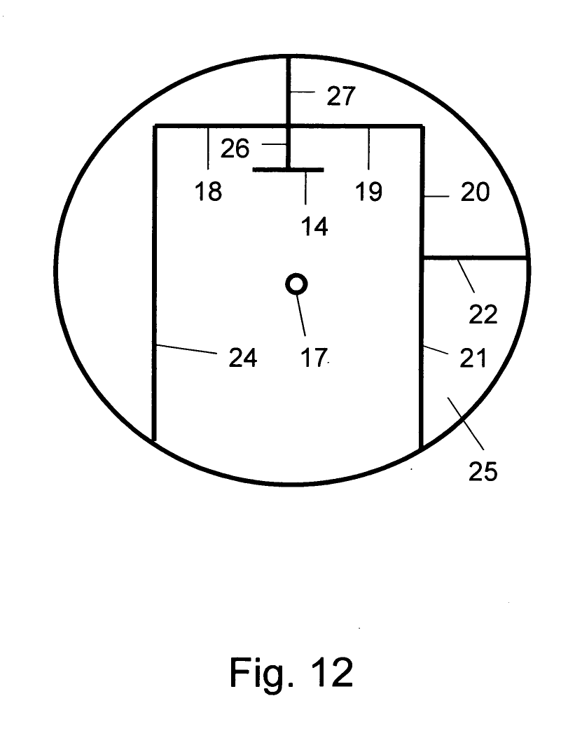

FIG. 12 provides a top view of the floor 25 of the multi-functional stapler platform 1. The chamber body 2 and the platform top 4 have been removed to facilitate this view. As can be seen in FIG. 12, the floor 25 is circular. In the preferred embodiment, the circumference of the floor 25 is from 11½ to 12 centimeters. There are a number of features on the floor 25 that are shown in FIG. 12. These features (items 14, 18, 19, 20, 21, 22, 24, and 26) are essentially narrow, flat walls that extend upwardly from the floor 25. In the preferred embodiment, these features are about 1 millimeter thick.

On the right-hand side of the floor 25 there is the drawer support structure that includes the front portion 21 of the right wall, the rear portion 20 of the right wall, and the drawer insertion guide 22. In the preferred embodiment, the length of the right wall (20 and 21 combined) is about 7½ centimeters. The drawer insertion guide 22 is about 1½ centimeters long at the base.

Toward the rear of the floor 25, is the left portion 18 of the rear wall, the right portion 19 of the rear wall and the pad stop 14. The pad stop is connected to the rear wall by a pad stop support wall 26. The pad stop support wall 26 braces the pad stop 14. In the preferred embodiment, the rear wall (18 and 19 combined) is about 8 centimeters long, so as to accommodate a note pad that is about 7½ centimeters wide. The pad stop is about 2 centimeters long and the pad stop support wall is about 1 centimeter long.

On the left side of the floor 25, there is also a left wall 24. This left wall 24 forms a part of the note pad compartment. Also, this left wall 24, together with the inner surface of the chamber body 2, forms the chamber for the adhesive flag dispenser.

There is also a wall 27 extending from the rear wall to the edge of the floor 25. This wall 27 serves to hold the chamber body 2 in place when it is placed over the floor 25. The outward edge of the wall 27 should be configured to fit against the inside surface of the chamber body 2 when the chamber body 2 is in place. Similarly, the front portion 21 of the right wall and the front of the left wall 24 serve this same purpose and should be configured to fit tightly against the inside surface of the chamber body 2.

In the preferred embodiment, the various walls on the floor (items 14, 18, 19, 20, 21, 22, 24, and 26) are, for the most part, about 1.5 centimeters high. The one exception is the right portion 19 of the rear wall, which is about 1.8 centimeters high. It is higher to serve as a guide for the drawer. It is possible to add a structure as a guide for the other side of the drawer to add stability. For example, there might be an L-shaped brace that hangs down from the underside of the platform top 4. The vertical leg of the “L” can act as a guide to prevent the drawer from moving side-to-side. The shorter, horizontal leg of the “L” can serve as a support for the drawer.

In the preferred embodiment, the chamber body 2 will fit tightly to the floor 25. Preferably, the side of the floor not seen in FIG. 12 is substantially flat. When the multi-purpose stapler platform 1 is fully assembled, the substantially flat sides of the disk 16 and the floor 25 are next to each other and the disk 16 and the floor 25 are held together by the rivet 17. The floor 25 (and therefore the rest of the upper portion of the multi-purpose stapler platform 1) can then be rotated around the rivet 17 while the disk 16 remains stationary.

One of ordinary skill in the art will appreciate that the techniques, structures and methods of the present invention above are exemplary. The present invention can be implemented in various embodiments without deviating from the scope of the invention.

1. A stapler platform, comprising: a housing, said housing having a stapler cradle formed therein, said stapler cradle being configured to accept and hold the base of a stapler; an note pad compartment formed within said housing that is configured to accept and hold a note pad and comprises an opening in said housing; a drawer compartment formed within said housing that is configured to accept and hold a drawer and comprises an opening in said housing; and a drawer.

2. The stapler platform of claim 1, further comprising an adhesive flag dispenser.

3. The stapler of claim 2, wherein the adhesive flag dispenser and the drawer compartment opening are located on opposing sides of said housing.

4. The stapler platform of claim 1, wherein the note pad compartment opening is at least 7 centimeters wide.

5. The stapler platform of claim 1, wherein the note pad compartment comprises a first wall that resides within said housing.

6. The stapler platform of claim 5, wherein said first wall is located within said housing such that, when the drawer is inserted into the drawer compartment, the drawer rests on said first wall.

7. The stapler platform of claim 6, wherein the note pad compartment comprises a second wall that resides within said housing.

8. The stapler platform of claim 7, wherein at least of a portion of said second wall is higher than said first wall.

9. The stapler platform of claim 7, further comprising a stop that stops a note pad that is inserted into said note pad compartment and that extends from said second wall.

10. The stapler platform of claim 6, further comprising a stop that stops the drawer when the drawer is inserted into the drawer compartment and that extends from said first wall.

11. The stapler platform of claim 1, wherein said drawer comprises a drawer face and open container, said open container having a bottom.

12. The stapler platform of claim 11, wherein, when the drawer is fully inserted into the drawer compartment, the drawer face extends well below the bottom of said open container.

13. The stapler platform of claim 1, wherein said stapler platform has a base and said housing can be rotated while the base remains stationary.
